(19) United States
(12) Patent Application Publication
(10) Pub. No.: US 2008/0251262 A1
(43) Pub. Date: Oct. 16, 2008

(54) Farrier's Tool and Method of Use.

(76) Inventor: STEPHEN H. WALKER, Sheridan, OR (US)

Correspondence Address: PETER A HAAS ESQUIRE LLC, 1929 SW 13TH AVE, PORTLAND, OR, 97201, US

(21) Appl. No.: 12/101,216

(22) Filed: Apr. 11, 2008

Related U.S. Application Data
(60) Provisional application No. 60/911,414, filed on Apr. 12, 2007.

(51) Int. Cl. A01L 11/00

(52) U.S. Cl. 168/48.1

(57) ABSTRACT

An improved farrier's tool consists of a generally planar body consisting of a substantially rectangular, rigid plate with two opposite flat faces, each face being well-suited for an abrasive body surface—one face consisting of a rasping surface and the opposite face consisting of a filing surface. The body, having a length greater than its width, includes a protruding handle member extending from the body and aligned centrally to the long-axis of the body. The handle member, further, being suitably adapted to receive a griping means such as a wooden or plastic handle element. Both the rasping and the filing surfaces include a repeating and continuous abrasion surface aligned substantially less than about 45-degrees from the cutting or travel direction of the tool.

### PRIORITY CLAIM

This present application claims benefit under 35 U.S.C. Section 119(e) of U.S. Provisional Patent Application Ser. No. 60/911,414, filed on 12 Apr. 2007, the disclosure of which is expressly incorporated by reference for all purposes.

### BACKGROUND

The present invention relates generally to farrier tools, and in particular to a combination farrier rasp and file and method of use.

Shoeing horses, a common practice to protect a horse's hooves and prevent damage to their feet, requires removal of the old, distal horn material to provide a structurally sound anchor for the shoe nails. The process of replacing old shoes and reconditioning hooves, typically performed every six to eight weeks, tends to be a significant and important aspect of a healthy horse.

The process of re-shoeing a horse's hoof, according to common practice in the art, includes lifting the horse's foot while the farrier stands with his back to the horse and places the uplifted horse's foot between his legs. The farrier bends over and extracts the several nails and removes the old shoe. Next, using a 2″ file, the farrier files and rasps the hoof to remove the old, distal horn material. Importantly, the farrier attempts to create a flat, level surface during the filing and rasping of the hoof. Because the common technique teaches use of a 2″ file or rasp, this requires considerable skill by the farrier and a certain amount of approximation. Also, the farrier selects a properly sized shoe for the hoof. Then, with a level surface to which the shoe attaches, the farrier nails the new shoe on the hoof.

One attempt to improve the standard 2-inch wide farrier's file of the prior art includes a device disclosed by Behney in U.S. Pat. No. 5,966,698 issued on 7 Dec. 1999. The disclosed device includes a substantially rectangular and flat body approximately 12-inches long by approximately 6-inches wide, with a rasp surface on one side and a file surface on the opposite side and two oppositely disposed handles aligned centrally along the long-axis of the body. The rasp portion of the tool includes a hoof-aligning-stop located near one of its narrower ends. And the file side includes a set of measurement markings to assist the farrier in selecting the appropriate size horseshoe. The Behney disclosure teaches a tool having a file and rasp surface at a 45-degree angle with respect to the longitudinal axis of the tool measured clockwise. And, further, the disclosure teaches two-handed operation using the supplied and oppositely disposed handles.

Yet, despite the traditional 2-inch file and the Behney device, there remains yet a need for an improved farrier's tool and method of use because the known devices do not enable a farrier to consistently and appropriately clean and prepare a horse's hoof for a shoe. With the 2-inch device of the prior art, considerable skill is required to properly prepare the hoof. And, with the Behney device, considerable effort is required to use the tool on the hoof because of its dimensions, which results in a heavy tool that requires a method using both hands on the tool.

Thus, there remains a need for an improved method of preparing the horn material of a horse's hoof in preparation for a shoe. Such a method should include an improved farrier's tool having a rasping surface broader than the width of the hoof and having a tooth pattern substantially less than 45-degrees. Moreover, such a method should be one-handed, enabling the farrier a free hand to steady himself, sooth the horse, or otherwise assist in the preparation of the hoof. The method should further include a technique that prevents biological material and horn material from clogging the rasp and file teeth. Such an improved method should further prepare the horn material in a manner suitable for a shoe, namely, having a substantially flat, planar and smooth surface as would be understood to be desirable by those skilled in this art. Finally, such an improved technique should require the minimal amount of time to prevent undue stress on the animal.

### SUMMARY OF THE INVENTION

The present invention overcomes limitations in the prior art by presenting an improved farrier's tool that requires only one-hand to manipulate, is light-weight, yet very effective in cleaning the hoof and preparing it with a flat surface. The improved tool according to the present invention further reduces the skill required to shoe a horse by providing a large, flat cutting surface that can still be operated single-handedly.

Other advantages of the tool include:
Enabling a farrier to use the tool with one hand;
Providing an improved technique and method to shoe a horse that reduces guesswork and requires less skill from the prior art method and tool;
Providing both a rasping tool and a file on a single cutting tool;
Improving the efficiency of each cut on the hoof surface;
Providing greater accuracy, planarity, and structural surface on the hoof;
Providing a light-weight design;
Providing a tool that is economical to manufacture; and
Enabling improved methods and techniques for farriers.

### DRAWING

FIG. 1 is a top view of an improved farrier's tool according to one preferred embodiment of the present invention.

FIG. 2 is a bottom view of the embodiment of FIG. 1.

FIG. 3 is a front view of the tool of FIG. 1.

FIG. 4 is a top view of the embodiment of FIG. 1 with a typical horseshoe to demonstrate relative size.

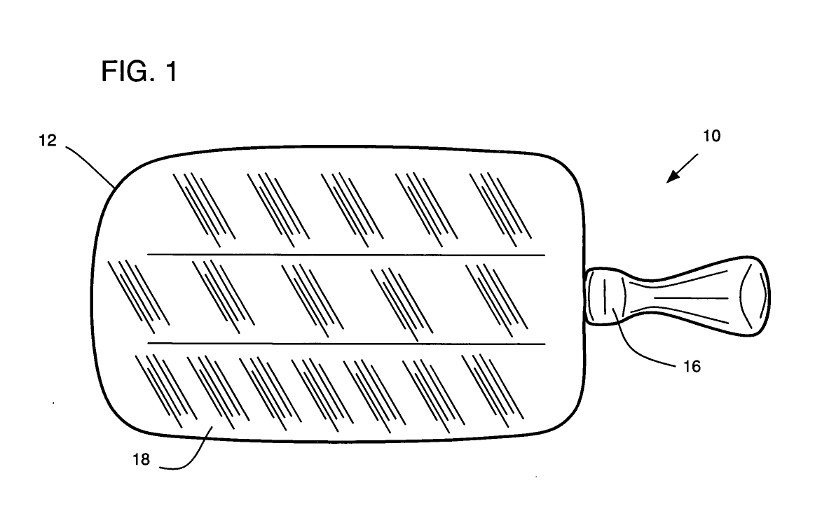

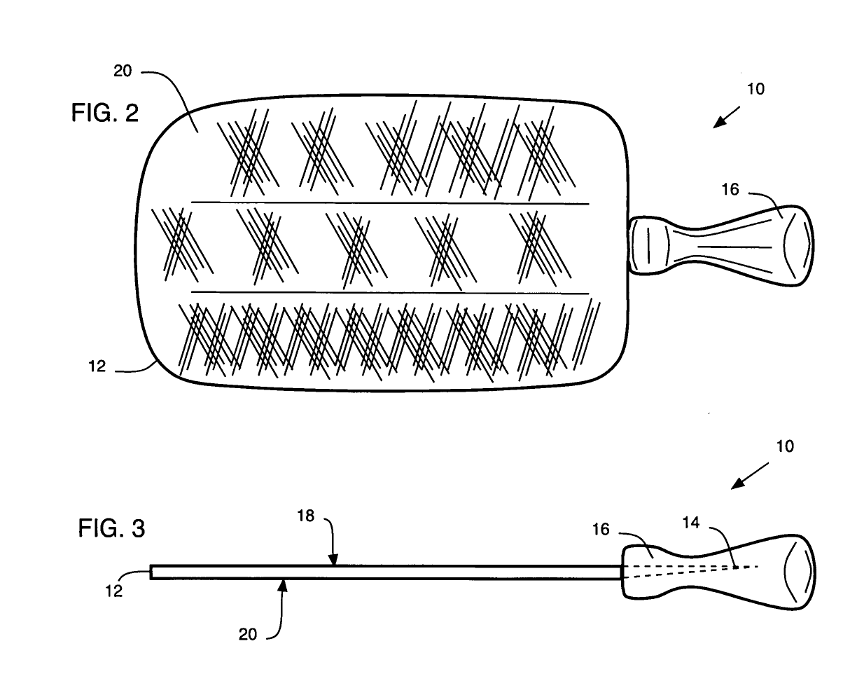

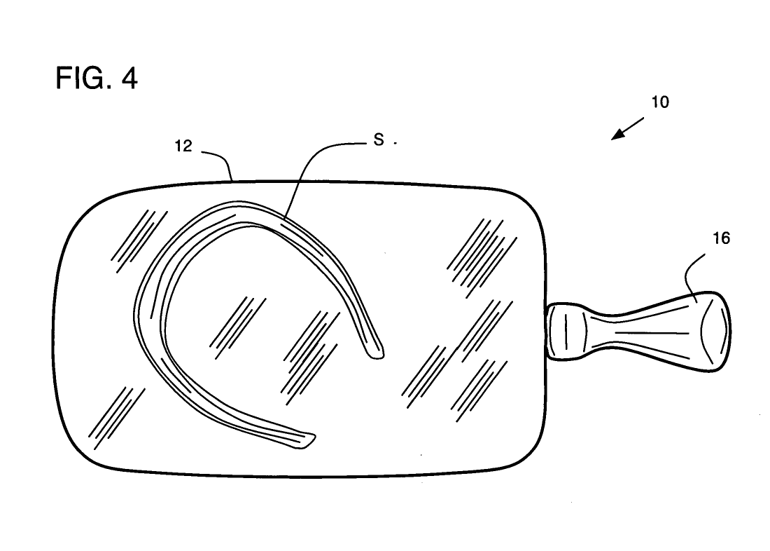

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

In one embodiment of the present invention an improved farrier's tool 10 consists of a generally planar body consisting of a substantially rectangular, rigid plate 12 with two opposite flat sides, well-suited for an abrasive body surface such as a file or rasp cutting surface. The body, having a length greater than its width, includes a protruding handle member extending from the body and aligned centrally to the long-axis of the body. The handle member, further, being suitably adapted to receive a griping means such as a wooden or plastic handle element.

Known prior-art devices include rasps and files having a planar body with a single protruding handle member—one side of the body has a file surface (also termed fine-finish) and the opposite side has a rasping surface. Such known devices range in size from about 1-inch to about 2.5-inches in width and about 12-inches to about 18-inches in length. Typical prior-art devices include the simmons-type hoof rasp, for example, available from www.fourwinds.net as model numbers 79-20, 79-555, and 79-77.

In a preferred embodiment the present invention is constructed of three 11″ long by about 2″ wide hoof rasps as commonly available. The two opposing longitudinal edges of each of these three rasps are cut down so that the edge is perpendicular to its corresponding rasp face and provides a straight and true edge for welding. The handle portions are removed from two of the 2″ rasps along with the rounded tip is removed from all three. The three rasps are arranged adjacent to each other so the longitudinal edges touch and the rasp patterns are matched in the same direction, the one 2″ rasp with the remaining handle is placed between the other two rasps with their handles removed. The seam from each adjoining rasp is welded to form about a 5″ to about 5 and ¾″ wide rasp device having a handle at one end and a blunt tip. The tip is now rounded and the edges rounded and de-burred. The seams are filed flat.

This design is superior to the existing 2″ rasp for several reasons. First, for example, it is wider than the hoof and more efficient in its use to remove the horn material. Second, for example, the rasp can support the weight of a pony without breaking. Other advantages of this preferred embodiment are further discussed herein. Suitable teeth, orientation, pattern, pitch, material, and formation thereof for the rasp surface are well-understood in this art. One suitable arrangement is described by Whyde in U.S. Pat. No. 4,598,447 issued on 8 Jul. 1986 and the entire disclosure is hereby incorporated by reference as if fully set forth herein.

In a preferred embodiment, the orientation of the file teeth and rasp teeth are about 35-degrees or less when measured from the long-axis of the tool. This results in an easier-to-use tool when removing horn material from the hoof when the preferred method according to the present invention is employed, as will be further explained herein.

The prior art device described by Behney in U.S. Pat. No. 5,996,698 consists of a planar body having two handle members oppositely disposed along the long-axis of the body and the body has a length of about 12-inches and a width of about 6-inches. The body further includes a measuring scale and the rasp pattern arranges 45-degrees relative to the long axis.

In contrast, the present invention comprises an improved farrier's tool 10 having a substantially planar body 12 having a length of about 11-inches and an overall width of about 5 and ⅛^{th} inches with a rasp patter arranged at about 30-35-degrees relative to a longitudinal axis. Protruding and extending from one end and centered with the long-axis of the body, a handle member 14 extends about 3-inches from the body and adapts to engage a gripping element 16 such as a wooden or plastic handle as is commonly used in this art. The body 12 includes two opposite faces, one face includes a file surface pattern 20 and the opposite face includes a rasp surface pattern 18. The overall length of the tool 10 is about 14-inches, and has a generally uniform thickness of about 3/16-inch and is constructed of iron or steel or other alloy of the type normally used to make files, rasps and other tools with an abrasive surface.

The file surface 20 consists of a cutting surface having ridges or teeth formed by crosscuts at some regular spacing that extends over and across the face of the surface, typically at an angle with respect to the cutting direction (or long axis of the body) of the tool. The rasp surface 18 includes a file-like surface with individual protruding points or teeth for a coarser cutting and trimming operation (when compared to the file surface). The file surface 20 and rasp surface 18 is distributed substantially throughout the respective face of the body 12; however, the appended drawings only illustrate a portion of the abrasive or cutting surface 18 or 20 for convenience. As generally used in this art, the rasp surface 18 and file surface 20 includes an abrasive or cutting pattern disposed substantially about 45-degrees from the travel or cutting direction of the tool 10. The cutting direction of the tool 10 arranges substantially parallel to the long axis of the body, as is common in this art.

The present invention contemplates a tool 10 that is advantageously sized to enable a farrier to efficiently prepare a hoof for a shoe and, simultaneously, eliminate or significantly reduce the amount of skill required and technique employed to render a clean and flat surface on the hoof. The preferred embodiments of the present invention are useful regardless of the hoof size or shoe size of the horse or animal. Common shoe sizes for horses, for example, include sub-miniature to size 6.

One contemplated method of using a tool 10 according to the present invention includes gripping the tool in one hand; steadying the horse's hoof with the opposite hand, cutting the surface of the hoof using the rasping surface of the tool in one-pass or motion; flipping the tool to align the opposite, filing surface with the horse's hoof; filing the surface of the hoof; releasing the tool; nailing a shoe as normal.

A preferred method according to the present invention includes the use of the improved farrier's tool described in the representative embodiments, above. Accordingly, one preferred method comprises a method of use of a farrier's tool, the tool being adapted for use in preparing a hoof for a shoe or for hygiene, wherein the tool includes a substantially planar body having a width no less than the width of the hoof, the body having a first face comprising a rasping surface having teeth arranged no more than 35-degrees clockwise relative to a longitudinal axis of the tool, the body further having a filing surface opposite the rasping surface, the body further having only one handle. The method further comprises: Gripping the tool in one hand; steadying the horse's hoof with the opposite hand and/or legs, and/or providing a support stand for the horse's leg; then using the second hand to palm the lead edge of the tool to help guide the travel direction during rotation and for applying pressure to the tool to evenly cut the horn material; cutting the horn of the hoof using the rasping surface of the tool in at least one-pass or motion, the motion being in a circular or rotation pattern clockwise followed by a similar circular pattern counter-clockwise (the order of clock-wise or counter-clockwise is not important, but both directions are required); flipping the tool to align the opposite, filing (fine-finish) surface with horn; and filing the horn material of the hoof, including the edge of the horn having been cut by the rasping surface of the tool. To finish the preparation, the razor-sharp edge now created by the rasping and fine finishing must be filed down. This edge is filed to about a 45-degree angle using the tool. Next, a shoe is sized, shaped, and nailed as would be generally understood in this art.

Additional steps of a preferred method include cleaning the hoof of debris, dirt, bacteria and other organic matter as well-understood in the art before the rasping and filing of the horn; shaping a shoe; nailing the shoe; trimming the nails, treating the hoof for any observed ailments; and other steps necessary and understood by farriers.

Although the invention has been particularly shown and described with reference to certain embodiments, it will be understood by those skilled in the art that various changes in form and detail may be made without departing from the spirit and scope of the invention.

I claim:

1. An improved farrier's tool comprising:
a substantially planar body comprising a substantially rectangular, rigid plate having a length greater than a width,
the body further including a protruding handle member extending from the body and aligned centrally to the long-axis of the body;
the handle member, further, being suitably adapted to receive a griping means such as a wooden or plastic handle element; and
the body further comprising a first face adapted for use as a filing abrasive surface and a second face disposed opposite the first face, the second face adapted for use as a rasping abrasive surface.

2. The tool of claim 1 wherein the body further comprises:
an overall width of no less than 5-inches and no greater than 5 and ¾-inches.

3. The tool of claim 1 further comprising:
a file pattern arranged less than 35-degrees clockwise relative to a longitudinal axis of the tool.

4. The tool of claim 1 further comprising:
a rasp pattern arranged less than 35-degrees clockwise relative to a longitudinal axis of the tool.

5. The tool of claim 1 wherein the body includes only one handle portion.

6. A method for use of a farrier's tool, the tool being adapted for use in preparing a hoof for a shoe or for hygiene, wherein the tool includes a substantially planar body having a width no less than the width of the hoof, the body having a first face comprising a rasping surface having teeth arranged no more than 35-degrees clockwise relative to a longitudinal axis of the tool, the body further having a filing surface opposite the rasping surface, the body further having only one handle, the method comprising:
gripping the tool in one hand;
using the second hand to palm the tool to modulate pressure on the hoof and otherwise direct and steady the tool relative to the hoof;
cutting the horn of the hoof using the rasping surface of the tool in at least one-pass or motion, the motion being in a rotation pattern clockwise;
cutting the horn of the hoof using the rasping surface of the tool in at least one-pass or motion, the motion being in a rotation pattern counter-clockwise;
flipping the tool to align the opposite, fine-finish surface with horn; and
fine-finishing the horn.

7. The method of claim 6 further comprising:
filing the edge of the horn material to about 45-degrees.
